(19) United States
(12) Patent Application Publication
(10) Pub. No.: US 2023/0204203 A1
(43) Pub. Date: Jun. 29, 2023

(54) Lighting Unit in a Modular System

(71) Applicant: Milwaukee Electric Tool Corporation, Brookfield, WI (US)

(72) Inventors: Scott L. Muelling, Waukesha, WI (US); Chelsea L. McCormick, Oak Creek, WI (US); John F. Koebl, Menomonee Falls, WI (US); Jessica L. Bulow, Milwaukee, WI (US); Daniel P. Butler, Wauwatosa, WI (US)

(21) Appl. No.: 18/067,443

(22) Filed: Dec. 16, 2022

Related U.S. Application Data
(63) Continuation of application No. PCT/US22/80819, filed on Dec. 2, 2022.
(60) Provisional application No. 63/285,849, filed on Dec. 3, 2021.

(51) Int. Cl. F21V 33/00; H02J 7/00; F21V 15/01; F21V 21/30; F21L 4/04

(52) U.S. Cl. CPC F21V 33/0084; H02J 7/0045; F21V 15/01; F21V 21/30; F21L 4/04

(57) ABSTRACT

A device or unit with a lighting panel is provided. The device includes one or more coupling components that couple the device or unit to other devices or units, such as within a modular storage system. In various embodiments, a battery charger and storage compartment are provided, and the battery charger is pivotally coupled to the housing.

### CROSS-REFERENCE TO RELATED PATENT APPLICATIONS

The present application is a continuation of International Application No. PCT/US2022/080819, filed Dec. 2, 2022, which claims the benefit of and priority to U.S. Provisional Application No. 63/285,849, filed on Dec. 3, 2021, each of which is incorporated herein by reference in its entirety.

### BACKGROUND OF THE INVENTION

The present disclosure is directed generally to the field of tool storage systems and related devices. The present disclosure relates specifically to a device or unit that optionally includes one or more light-emitting components, and a coupling mechanism to detachably couple the device to another such device or container, such as a tool storage container in a modular tool storage system.

Tool storage units are often used to transport tools and tool accessories. Some storage units are designed to incorporate within a modular storage system. Within a modular storage system, different units, devices and/or containers may provide varying functions, such as being adapted to provide light and/or to provide storage.

### SUMMARY OF THE INVENTION

One embodiment of the invention relates to a stackable unit configured to couple to a storage unit. The stackable unit includes a housing, a lower surface defined by the housing, a plurality of male couplers extending from the lower surface, the plurality of male couplers configured to couple the lower surface of the stackable unit to a top surface of the storage unit, a light pivotally coupled to the housing, and a battery interface pivotally coupled to the housing. The battery interface is configured to couple to a rechargeable power tool battery.

In various embodiments, the stackable unit includes a lid pivotally coupled to the housing such that the lid and the housing collectively define a first compartment in which the battery interface is located. The lid pivots about a first axis with respect to the housing. In various embodiments, the light pivots about a second axis with respect to the lid, and the first axis is not colinear with the second axis. In various embodiments, the first axis is perpendicular to the second axis.

In various embodiments, the stackable unit includes a second lid pivotally coupled to the housing, the second lid pivoting about a third axis with respect to the housing. The second lid and the housing collectively define a second compartment distinct from the first compartment. In various embodiments, the battery interface pivots between a first position in which the rechargeable power tool battery extends vertically from the battery interface, and a second position in which the rechargeable power tool battery extends laterally from the battery interface.

In various embodiments, the stackable unit includes a lid pivotally coupled to the housing such that the lid and the housing collectively define a compartment in which the battery interface is located. The lid pivots about a first axis with respect to the housing, and the lid can be closed when the battery interface is in the second position and the rechargeable power tool battery is coupled to the battery interface. In various embodiments, the lid cannot be closed when the battery interface is in the first position and the rechargeable power tool battery is coupled to the battery interface. In various embodiments, the rechargeable power tool battery rests on a top surface of the stackable unit when the rechargeable power tool battery is coupled to the battery interface and the battery interface is in the first position. In various embodiments, the battery interface rotates about a fourth axis with respect to the housing, and the fourth axis is parallel to the first axis.

Another embodiment of the invention relates to a stackable unit configured to couple to a storage unit. The stackable unit includes a housing, a lower surface defined by the housing, a plurality of male couplers extending from the lower surface, the plurality of male couplers configured to couple the lower surface of the stackable unit to a top surface of the storage unit, a battery interface configured to couple to a rechargeable power tool battery, a lid pivotally coupled to the housing, the lid pivoting about a first axis with respect to the housing, and a light pivotally coupled to the lid such that the light pivots about a second axis with respect to the lid. The first axis and the second axis are distinct from each other.

In various embodiments, the lid and the housing collectively define a first compartment. In various embodiments, the first axis is parallel to the second axis. In various embodiments, the stackable unit includes a second lid pivotally coupled to the housing, the second lid and the housing collectively defining a second compartment in which the battery interface is located. In various embodiments, the battery interface pivots between a first position and a second position, and the second lid can be closed when the battery interface is in the second position and the rechargeable power tool battery is coupled to the battery interface. In various embodiments, the second lid cannot be closed when the battery interface is in the first position and the rechargeable power tool battery is coupled to the battery interface.

Another embodiment of the invention relates to a stackable unit configured to couple to a storage unit. The stackable unit includes a housing, a lower surface defined by the housing, a plurality of male couplers extending from the lower surface, the plurality of male couplers configured to couple the lower surface of the stackable unit to a top surface of the storage unit, a lid pivotally coupled to a top of the housing, the lid pivoting about a first axis with respect to the housing, one or more magnets coupled to the lid, the magnets configured to facilitate retention of fasteners to an upper surface of the stackable unit, and a battery interface pivotally coupled to the housing. The battery interface configured to couple to a rechargeable power tool battery.

In various embodiments, the battery interface pivots between a first position and a second position, and the lid cannot be closed when the battery interface is in the first position and the rechargeable power tool battery is coupled to the battery interface, and the lid can be closed when the battery interface is in the second position and the rechargeable power tool battery is coupled to the battery interface. In various embodiments, the stackable unit includes a light coupled to the housing.

Another embodiment of the invention relates to a stackable unit configured to couple to a stackable storage unit. The stackable unit includes a housing, a lower surface defined by the housing, a plurality of male couplers, a light panel, and a battery interface. The plurality of male couplers extend from the lower surface of the housing. The plurality of male couplers are configured to couple the lower surface of the stackable unit to a surface of a stackable storage unit, such as an upper surface. The light panel is pivotally coupled to the housing. The battery interface is pivotally coupled to the housing and is configured to couple to a rechargeable power tool battery.

Another embodiment of the invention relates to a stackable unit configured to couple to a stackable storage unit. The stackable unit includes a housing, a lower surface defined by the housing, a plurality of male couplers, a battery interface configured to couple to a rechargeable power tool battery, a lid pivotally coupled to the housing, and a light panel pivotally coupled to the lid. The plurality of male couplers extend from the lower surface. The plurality of male couplers are configured to couple the lower surface of the stackable unit to a top surface of a stackable storage unit. The lid is pivotally coupled to the housing such that the lid pivots about a first axis with respect to the housing.

In various embodiments, the light panel pivots with respect to the lid about a second axis, and the first axis and second axis are distinct from each other.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a stackable unit, according to an exemplary embodiment.

FIG. 2 is a perspective view of a portion of the stackable unit of FIG. 1, according to an exemplary embodiment.

FIG. 3 is a side view of the stackable unit of FIG. 1, according to an exemplary embodiment.

FIG. 4 is a perspective view of the stackable unit of FIG. 1, according to an exemplary embodiment.

FIG. 5 is a perspective view from below of the stackable unit of FIG. 1, according to an exemplary embodiment.

FIG. 6 is a side view of the stackable unit of FIG. 1, according to an exemplary embodiment.

FIG. 7 is a side view of the stackable unit of FIG. 1, according to an exemplary embodiment.

FIG. 8 is a side view of the stackable unit of FIG. 1, according to an exemplary embodiment.

FIG. 9 is a top view of the stackable unit of FIG. 1, according to an exemplary embodiment.

FIG. 10 is a perspective view from above and behind of a portion of the stackable unit of FIG. 1, according to an exemplary embodiment.

FIG. 11 is a perspective view of a system including the stackable unit of FIG. 1 and a storage unit, according to an exemplary embodiment.

### DETAILED DESCRIPTION

Referring generally to the figures, an embodiment of a stackable lighting device, container or unit is shown. One or more of the devices are configured to selectively couple and decouple with storage units, such as tool storage units within a modular storage system. The stackable lighting unit includes one or more lighting panels that can be used to illuminate nearby objects and surfaces. The stackable lighting unit includes a battery charger for rechargeable power tool batteries. In various embodiments the battery charger is pivotally coupled to the housing, thereby permitting the user to position the power tool battery in at least two different positions when the power tool battery is being charged.

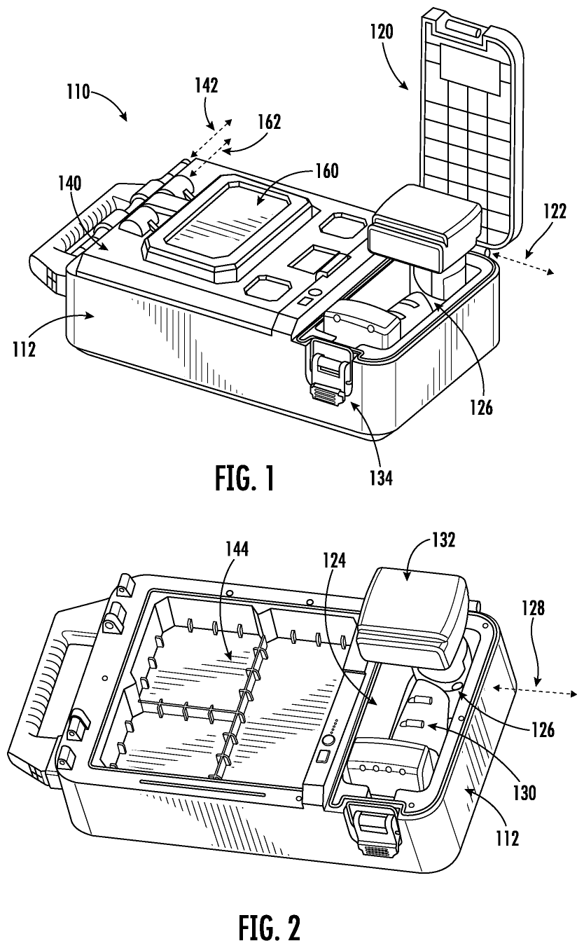

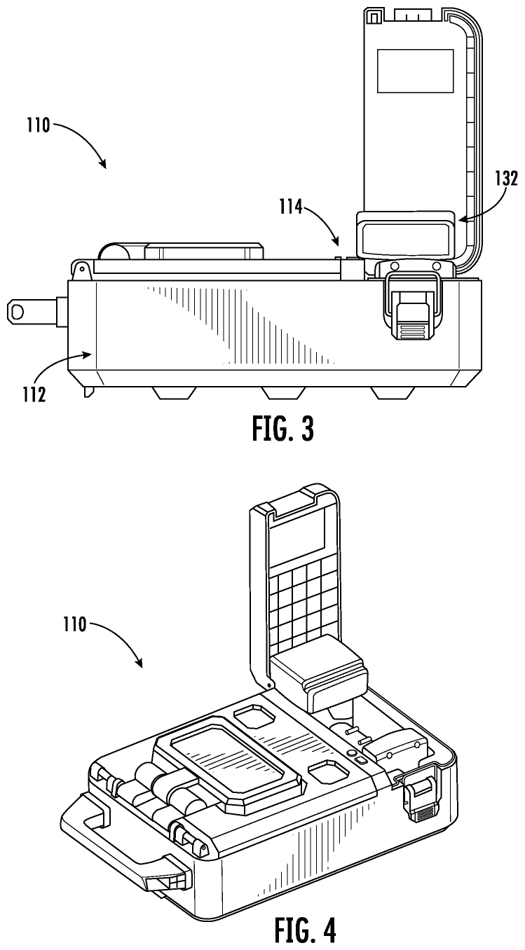

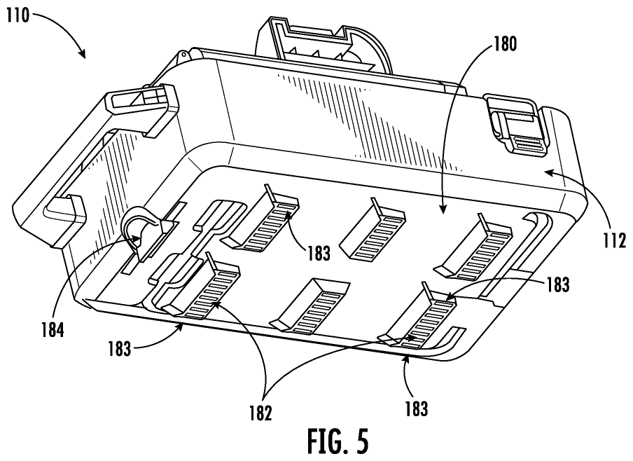

Referring to FIGS. 1-4, a stackable device, shown as stackable unit 110, is shown according to an exemplary embodiment. Stackable unit 110 includes housing 112, a lower surface 180 defined by housing 112, first top panel 120 (e.g., first lid) pivotally coupled to housing 112, second top panel 140 (e.g., second lid) pivotally coupled to housing 112, and light 160 pivotally coupled to housing 112. In various embodiments, light 160 is pivotally coupled to housing 112 via being pivotally and directly coupled to second top panel 140.

First top panel 120 is pivotally coupled to housing 112 such that top panel 120 and housing 112 collectively define compartment 124 in which the battery interface 126 is located. Top panel 120 pivots about axis 122 with respect to housing 112, and second top panel 140 pivots about axis 142 with respect to housing 112. Latch 134 is coupled to housing 112 and is configured to secure first top panel 120 against housing 112 (e.g., when first top panel 120 is in the closed position). Light 160 pivots about axis 162 with respect to second top panel 140 and/or housing 112. In various embodiments, because light 160 is coupled to second top panel 140, light 160 also pivots with respect to housing 112 about axis 142 (e.g., when second top panel 140 is being pivoted). In various embodiments, axis 162 is distinct from and parallel to axis 142. In various embodiments, axis 122 is perpendicular to one or both of axis 142 and axis 162. In various embodiments, one or more of first top panel 120 and second top panel 140 includes magnets to facilitate retention of jobsite fasteners (e.g., screws, bolts, nuts), such as to upper surface 114 of stackable unit 110. In various embodiments, axis 122 is not colinear with axis 162, such as because axis 122 is perpendicular to axis 162.

Referring to FIG. 2, stackable unit 110 is shown without first top panel 120 and second top panel 140, thereby exposing compartment 124 and compartment 144, respectively. Second top panel 140 and housing 112 collectively define compartment 144, which in various embodiments is distinct from the compartment 124. In various embodiments battery interface 126 is pivotally coupled to housing 112 such that battery interface 126 pivots about axis 128 with respect to housing 112. In various embodiments, axis 128 is parallel to axis 122 and perpendicular to one or more of axis 142 and axis 162. Battery interface 126 is configured to couple to a rechargeable power tool battery 130, 132.

In particular, battery interface 126 can be pivoted between a first position, in which the rechargeable power tool battery 132 extends vertically from the battery interface 126, and a second position, in which the rechargeable power tool battery 130 extends laterally from the battery interface 126. Top panel 120 is pivotally coupled to the housing 112 such that the top panel 120 and the housing 112 collectively define a compartment 124 in which the battery interface 126 is located, and the top panel 120 pivots about a first axis 122 with respect to the housing 112, and the lid 120 can be closed when the battery interface 126 is in the second position and the rechargeable power tool battery 130 is coupled to the battery interface 126. Top panel 120 can be closed when the battery interface 126 is in the second position and the rechargeable power tool battery 132 is coupled to the battery interface 126.

To show both positions in a single figure, rechargeable power tool battery 132 (in first position) is shown in ghost view and superimposed with rechargeable power tool battery 130 (in second position). Thus, FIG. 1-4 show both the first position and the second position, although it will be understood that in use the battery interface 126 will be oriented in either the first position and the second position but not both contemporaneously.

When battery interface 126 is in the first position, rechargeable power tool battery 130 extends vertically out of compartment 124. This positioning for battery interface 126 permits easy insertion of the rechargeable power tool battery 130 (e.g., vertically into the battery interface 126). In various embodiments, rechargeable power tool battery 132 abuts against (e.g., rests on) an upper surface 114 of housing 112 and/or stackable unit 110 when the rechargeable power tool battery 132 is coupled to the battery interface 126 and the battery interface 126 is in the first position. This positioning provides protection and support from damaging battery interface 126 and/or rechargeable power tool battery 130 if stackable unit 110 is dropped. When battery interface 126 is in the first position, rechargeable power tool battery 132 extends vertically out of compartment 124.

When battery interface 126 is in the second position, rechargeable power tool battery 132 extends laterally within compartment 124. This positioning for battery interface 126 permits rechargeable power tool battery 132 to have a low profile, such as a sufficiently low profile to permit first top panel 120 to be pivoted shut.

Referring to FIG. 5, housing 112 defines lower surface 180. Stacking unit 110 includes a plurality of male couplers 182 extending from the lower surface 180, the plurality of male couplers 182 configured to couple the lower surface 180 of the stackable unit 110 to a top surface 192 of a storage unit 190 (FIG. 11). In various embodiments one or more male couplers 182 extend from lower surface 180. The one or more male couplers 182 include one or more ribs 183 that extend along a side of the respective male coupler 182, such as two ribs 183 extending along opposing sides of the respective male coupler 182. In various embodiments the ribs 183 of the one or more male couplers 182 extend above and are offset from lower surface 180, and ribs 183 engage with tongues of female couplers 194 of a corresponding unit (FIG. 11). In various embodiments the stackable unit 110 includes a coupling element, such as a rafter hook, mounted on a bottom of the stackable unit 110 and configured to hand the stackable unit 110 on a board or other element.

Latch 184 is configured to engage with a latch recess in a modular unit that stackable unit 110 is coupled to. For example, one or more of the male couplers 182 engage with one or more corresponding female couplers of the modular unit. Engagement between the latch 184 and the corresponding latch recess of the modular unit prevents disengagement between the male couplers 182 and the female couplers of the modular unit, such as by preventing sliding disengagement.

In various embodiments, male couplers 182 and latch 184 are compatible with the coupling mechanism(s) described in International Patent Publication No. WO 2017/191628, which is hereby incorporated by reference in its entirety.

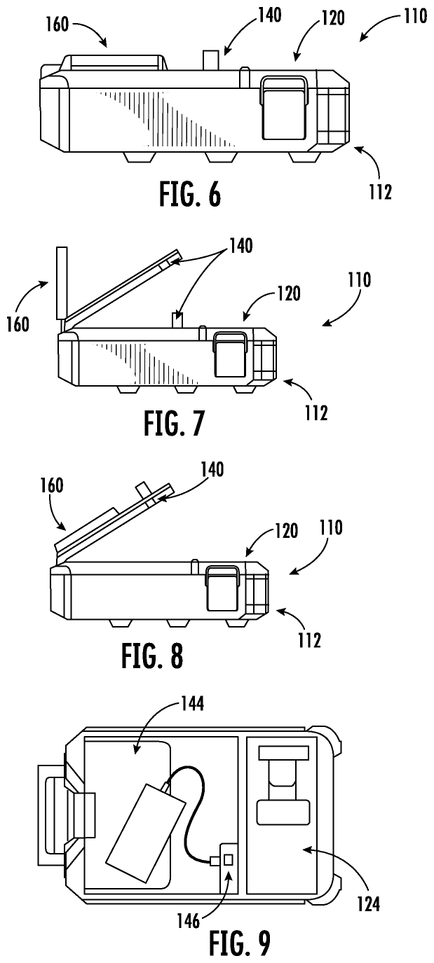

Referring to FIGS. 6-8, various configurations of stackable unit 110 are shown. In particular, first top panel 120, second top panel 140 and light 160 are shown in various orientations with respect to housing 112.

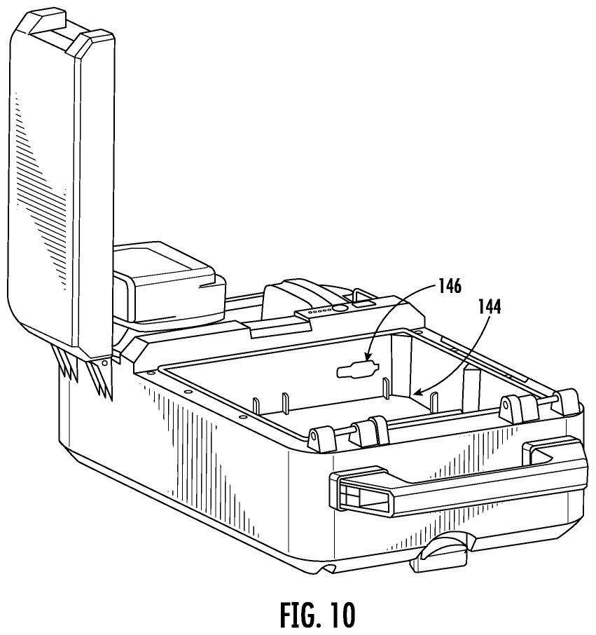

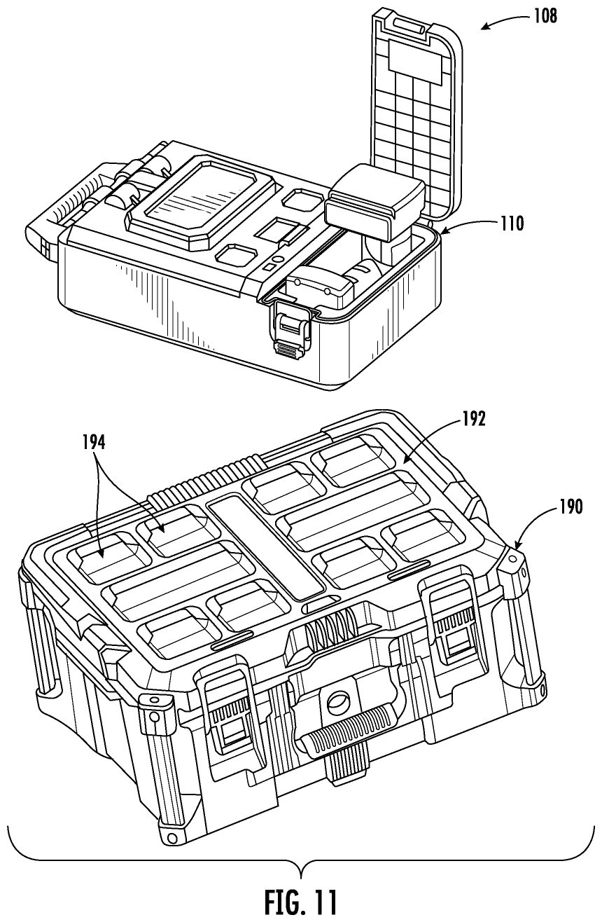

Referring to FIGS. 9-10, various aspects of stackable unit 110 are shown. In various embodiments stackable unit 110 includes an electrical outlet, shown as USB outlet(s) 146. USB outlet(s) 146 are configured to provide power, such as power received from a power cord plugged into an electrical outlet in a wall (e.g., AC current), which also powers light 160. In various embodiments USB outlet(s) 146 include multiple USB outlets, such as a USB A outlet and a USB C outlet. In various embodiments a personal electronic device, shown as cell phone, can be recharged via one of the USB outlet(s) 146. In various embodiments, light 160 and one or more of USB outlet(s) 146 receive power from a power cord.

In various embodiments each of compartment 124 and compartment 144 are sealed, such being sealed as from liquid entering compartment 124 and compartment 144. In various embodiments stackable unit 110 includes electronics within housing 112, and the electronics is sealed from debris and/or liquid at least in part because of the seals for compartment 124 and compartment 144.

Referring to FIG. 11, various aspects system 108 are shown. System 108 includes stackable unit 110 and storage unit 190. Storage unit 190 includes a top surface 192 and one or more female couplers 194 defined by top surface 192.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A stackable unit configured to couple to a storage unit, the stackable unit comprising:
a housing;
a lower surface defined by the housing;
a plurality of male couplers extending from the lower surface, the plurality of male couplers configured to couple the lower surface of the stackable unit to a top surface of the storage unit;
a light pivotally coupled to the housing; and
a battery interface pivotally coupled to the housing, the battery interface configured to couple to a rechargeable power tool battery.

2. The stackable unit of claim 1, comprising a lid pivotally coupled to the housing such that the lid and the housing collectively define a first compartment in which the battery interface is located, wherein the lid pivots about a first axis with respect to the housing.

3. The stackable unit of claim 2, wherein the light pivots about a second axis with respect to the lid, and the first axis is not colinear with the second axis.

4. The stackable unit of claim 3, wherein the first axis is perpendicular to the second axis.

5. The stackable unit of claim 2, comprising a second lid pivotally coupled to the housing, the second lid pivoting about a third axis with respect to the housing, wherein the second lid and the housing collectively define a second compartment distinct from the first compartment.

6. The stackable unit of claim 5, wherein the third axis and the first axis are perpendicular to each other.

7. The stackable unit of claim 1, wherein the battery interface pivots between a first position in which the rechargeable power tool battery extends vertically from the battery interface, and a second position in which the rechargeable power tool battery extends laterally from the battery interface.

8. The stackable unit of claim 7, comprising a lid pivotally coupled to the housing such that the lid and the housing collectively define a compartment in which the battery interface is located, wherein the lid pivots about a first axis with respect to the housing, wherein the lid can be closed when the battery interface is in the second position and the rechargeable power tool battery is coupled to the battery interface.

9. The stackable unit of claim 8, wherein the lid cannot be closed when the battery interface is in the first position and the rechargeable power tool battery is coupled to the battery interface.

10. The stackable unit of claim 9, wherein the rechargeable power tool battery rests on a top surface of the stackable unit when the rechargeable power tool battery is coupled to the battery interface and the battery interface is in the first position.

11. The stackable unit of claim 8, wherein the battery interface rotates about a fourth axis with respect to the housing, and wherein the fourth axis is parallel to the first axis.

12. A stackable unit configured to couple to a storage unit, the stackable unit comprising:
a housing;
a lower surface defined by the housing;
a plurality of male couplers extending from the lower surface, the plurality of male couplers configured to couple the lower surface of the stackable unit to a top surface of the storage unit;
a battery interface configured to couple to a rechargeable power tool battery;
a lid pivotally coupled to the housing, the lid pivoting about a first axis with respect to the housing; and
a light pivotally coupled to the lid such that the light pivots about a second axis with respect to the lid, the first axis and the second axis being distinct from each other.

13. The stackable unit of claim 12, wherein the lid and the housing collectively define a first compartment.

14. The stackable unit of claim 12, wherein the first axis is parallel to the second axis.

15. The stackable unit of claim 12, comprising a second lid pivotally coupled to the housing, wherein the second lid and the housing collectively define a second compartment in which the battery interface is located.

16. The stackable unit of claim 15, wherein the battery interface pivots between a first position and a second position, wherein the second lid can be closed when the battery interface is in the second position and the rechargeable power tool battery is coupled to the battery interface.

17. The stackable unit of claim 16, wherein the second lid cannot be closed when the battery interface is in the first position and the rechargeable power tool battery is coupled to the battery interface.

18. A stackable unit configured to couple to a storage unit, the stackable unit comprising:
a housing;
a lower surface defined by the housing;
a plurality of male couplers extending from the lower surface, the plurality of male couplers configured to couple the lower surface of the stackable unit to a top surface of the storage unit;
a lid pivotally coupled to a top of the housing, the lid pivoting about a first axis with respect to the housing;
one or more magnets coupled to the lid, the magnets configured to facilitate retention of fasteners to an upper surface of the stackable unit; and
a battery interface pivotally coupled to the housing, the battery interface configured to couple to a rechargeable power tool battery.

19. The stackable unit of claim 18, wherein the battery interface pivots between a first position and a second position, wherein the lid cannot be closed when the battery interface is in the first position and the rechargeable power tool battery is coupled to the battery interface, and wherein the lid can be closed when the battery interface is in the second position and the rechargeable power tool battery is coupled to the battery interface.

20. The stackable unit of claim 18, comprising a light coupled to the housing.
